(19) United States
(12) Patent Application Publication
(10) Pub. No.: US 2023/0413220 A1
(43) Pub. Date: Dec. 21, 2023

(54) WIRELESS COMMUNICATION MODULE AND SERVER WITH THE SAME

(71) Applicant: Shenzhen Fulian Fugui Precision Industry Co., Ltd., Shenzhen (CN)

(72) Inventors: LIN ZHANG, Shenzhen (CN); LI-WEN GUO, Shenzhen (CN); KE-FENG YOU, Shenzhen (CN)

(21) Appl. No.: 18/115,646

(22) Filed: Feb. 28, 2023

(30) Foreign Application Priority Data
May 27, 2022 (CN) 202210593908.2

(51) Int. Cl. H04W 64/00; H04W 72/0453

(52) U.S. Cl. CPC H04W 64/003; H04W 72/0453

(57) ABSTRACT

A wireless communication module is provided. The wireless communication module is configured to be installed on a server. The wireless communication module includes a carrier and a first wireless communication unit. The carrier is configured to be electrically coupled to the server. The first wireless communication unit is arranged on the carrier, and is electrically coupled to the carrier. The first wireless communication unit is configured to be controlled by the server via the carrier to emit and/or receive the radio wave. A related server is also provided.

### FIELD

The subject matter herein generally relates to wireless communication technology, and particularly to a wireless communication module and a server with the same.

### BACKGROUND

As an industrial internet develops rapidly, more and more edge servers are input to use. The edge server is a server which usually complete a single function. The main work environment of the edge server is a nonstandard equipment room environment, for example, an environment where the wired network interface is not equipped, such as a shopping or a roadside. Thus, how the edge server accesses the network is one of main problems to be urgently solved at present.

### SUMMARY

An embodiment of the present application provides a wireless communication module and a server with the same which are capable of coupling the server to a wireless network conveniently.

In a first aspect, an embodiment of the present application provides a wireless communication module. The wireless communication module is configured to be installed on a server. The wireless communication module includes a carrier and a first wireless communication unit. The first wireless communication unit is arranged on the carrier, and is electrically coupled to the carrier. The carrier is further configured to be electrically coupled to the server. The first wireless communication unit is configured to be controlled by the server via the carrier to emit and/or receive the radio wave.

According to some embodiments of the present application, the carrier is a printed circuit board.

According to some embodiments of the present application, the carrier is configured to be electrically coupled to the server via a universal serial bus, the first wireless communication unit is configured to be controlled by the server via the carrier and the universal serial bus to emit and/or receive the radio wave.

According to some embodiments of the present application, the wireless communication module further includes a second wireless communication unit. The second wireless communication unit is arranged on the carrier, and is electrically coupled to the carrier. The carrier is configured to be electrically coupled to the server via a peripheral component interconnect express bus. The second wireless communication unit is configured to be controlled by the server via the carrier and the peripheral component interconnect express bus to emit and/or receive the radio wave.

According to some embodiments of the present application, the first wireless communication unit uses a long term evolution communication technology or a 5G communication technology, and the second wireless communication unit uses a wireless fidelity communication technology.

According to some embodiments of the present application, the wireless communication module further includes a temperature detection unit. The temperature detection unit is arranged on the carrier, and is electrically coupled to the carrier. The temperature detection unit is electrically coupled to the server via the carrier. The temperature detection unit is arranged adjacent the first wireless communication unit. The temperature detection unit is configured to detect a temperature of the first wireless communication unit, and is configured to provide the temperature of the first wireless communication unit to the server via the carrier.

According to some embodiments of the present application, the wireless communication module further includes a positioning unit. The positioning unit is arranged on the carrier, and is electrically coupled to the carrier. The positioning unit is configured to be electrically coupled to the server via the carrier. The positioning unit is configured to provide position information to the server via the carrier.

In a second aspect, an embodiment of the present application provides a server. The server includes a wireless communication module. The wireless communication module is installed on the server. The wireless communication module includes a carrier and a first wireless communication unit. The first wireless communication unit is arranged on the carrier, and is electrically coupled to the carrier. The carrier is further electrically coupled to the server. The first wireless communication unit is controlled by the server via the carrier to emit and/or receive the radio wave.

In the disclosure, the wireless communication module and the server with the same can cause the server to equip the first wireless communication unit via the carrier. The server can be directly coupled to the wireless network, but not be coupled to the wireless network via a network cable. Thus, a freedom of the server is improved, the server can adapt to more application scenarios and satisfy a usage requirement of an existing industrial internet.

### BRIEF DESCRIPTION OF THE DRAWINGS

Many aspects of the disclosure can be better understood with reference to the following drawings. The components in the drawings are not necessarily drawn to scale, the emphasis instead being placed upon clearly illustrating the principles of the disclosure. Moreover, in the drawings, like reference numerals designate corresponding parts throughout the several views.

FIG. 1 is a schematic view of an embodiment of a server communicating with an external device.

FIG. 2 is a block diagram of an embodiment of the server of the FIG. 1.

### DETAILED DESCRIPTION

Implementations of the disclosure will now be described, by way of embodiments only, with reference to the drawings. The disclosure is illustrative only, and changes may be made in the detail within the principles of the present disclosure. It will therefore be appreciated that the embodiments may be modified within the scope of the claims.

It should be noted that, when an element is referred to as being “electrically coupled to” another element, the element can be directly on the other element or intervening elements may also be present. When an element is described as “electrically coupled to” another element, the coupling can be a contact connection, for example, can be a wired connection manner, or can be a contactless connection, for example, can be a contactless coupling manner.

Unless otherwise defined, all technical and scientific terms used in this text have the same meaning as commonly understood by persons skilled in the art to which the present invention belongs. The terms used in the description of the present invention are for the purpose of describing the specific embodiments only, and are not intended to limit the present invention. The term “and/or” used in this text includes any and all combinations of one or more of the associated listed items.

In the present disclosure, unless specified or limited otherwise, it is to be understood that terms such as “above,” “under,” “upper end,” “lower end,” “upper surface,” “lower surface,” “clockwise,” “counterclockwise,” “left,” and “right,” should be construed to refer to the orientation as then described or as shown in the drawings under discussion. These relative terms are for convenience of description and do not require that the device or element be constructed or operated in a particular orientation, shall not be construed to limit the present disclosure.

In the present disclosure, unless specified or limited otherwise, a structure in which a first feature is “on” or “below” a second feature may include an embodiment in which the first feature is in direct contact with the second feature, and may also include an embodiment in which the first feature and the second feature are not in direct contact with each other, but are contacted via an additional feature formed therebetween. Furthermore, a first feature “on,” “below,” or “on top of” a second feature may include an embodiment in which the first feature is right or obliquely “on,” “below,” or “on top of” the second feature, or just means that the first feature is at a height higher than that of the second feature; while a first feature “above,” “under,” or “on bottom of” a second feature may include an embodiment in which the first feature is right or obliquely “above,” “under,” or “on bottom of” the second feature, or just means that the first feature is at a height lower than that of the second feature.

In addition, terms such as “first” and “second” are used herein for purposes of description and are not intended to indicate or imply relative importance or significance or to imply the number of indicated technical features. Thus, the feature defined with “first” and “second” may comprise one or more of this feature.

The following descriptions explain example embodiments of the present disclosure, with reference to the accompanying drawings. Unless otherwise noted as having an obvious conflict, the embodiments or features included in various embodiments may be combined.

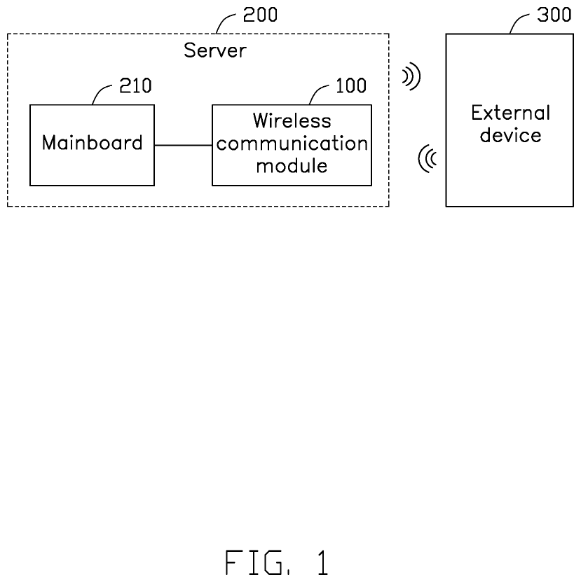

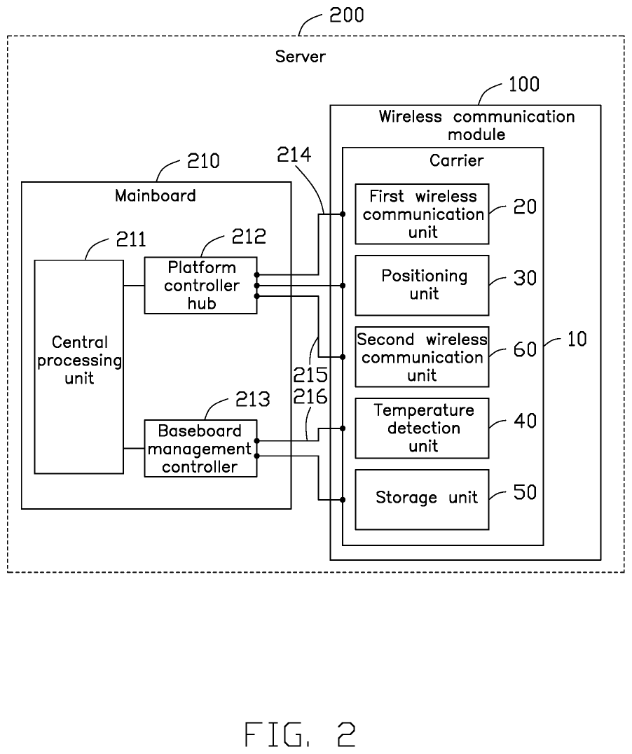

Referring to FIGS. 1-2, a wireless communication module 100 is provided. The wireless communication module 100 is installed on a server 200. The wireless communication module 100 is configured to emit and/or receive a radio wave, to pass and/or exchange a wireless signal. Thus, the server 200 can communicate conveniently with a base station, a cloud server, or other external device 300, and a signal transmission is thereby completed. The external device 300 can be any suitable electronic device, for example, a smart home device, an industrial internet device, a smart medical device, or the like.

It can be understood that, the server 200 can be applied in an electronic device. The electronic device includes, but is not limited to, a mobile terminal or an immobile terminal. The mobile terminal or the immobile terminal can be, for example, a ultra-mobile personal computer (UMPC), a handheld computer, a netbook, a personal digital assistant (PDA), a wearable device, a virtual reality device, a wireless USB flash drive, a Bluetooth speaker/headset, an on-vehicle device, an event data recorder, a security device, a medical device, or the like.

It can be understood that, the server 200 can be further electrically coupled to a display, a keyboard, a mouse, or other peripheral devices, to facilitate interaction with a user.

It can be understood that, the wireless communication module 100 is electrically coupled to a mainboard 210 in the server 200. Thus, the wireless communication module 100 can covert first information outputted from the mainboard 210 to a wireless signal, and emit the wireless signal outward. The wireless communication module 100 can simultaneously receive second information from the base station, the cloud server, or the other external device 300, and transmit the second information to the mainboard 210.

In the embodiment, the wireless communication module 100 includes a carrier 10, a first wireless communication unit 20, a positioning unit 30, one or more temperature detection units 40, and a storage unit 50. Where, the first wireless communication unit 20, the positioning unit 30, the one or more temperature detection units 40, and the storage unit 50 each is arranged on the carrier 10, and each is electrically coupled to the carrier 10. For example, in the embodiment, the first wireless communication unit 20, the positioning unit 30, the one or more temperature detection units 40, and the storage unit 50 each is soldered on the carrier 10. Thus, the first wireless communication unit 20, the positioning unit 30, the one or more temperature detection units 40, and the storage unit 50 each is stably electrically coupled to the carrier 10.

It can be understood that, the mainboard 210 does not equip one or more interfaces to couple to the first wireless communication unit 20, the positioning unit 30, the one or more temperature detection units 40, and the storage unit 50. Thus, if the first wireless communication unit 20, the positioning unit 30, the one or more temperature detection units 40, and the storage unit 50 each is directly electrically coupled to the mainboard 210, for a mismatch between the first wireless communication unit 20, the positioning unit 30, the one or more temperature detection units 40, and the storage unit 50 each's power supply and signal and the mainboard 210's power supply and signal, a serious consequence is easily generated. The serious consequence can be, for example, a confusion of the signal, a loss of the data, or the like. Evenly, a damage of the server 200 may be caused. In the disclosure, via equipping the carrier the first wireless communication unit 20, the positioning unit 30, the one or more temperature detection units 40, and the storage unit 50 each can be electrically coupled to the mainboard 210 via the carrier 10, thus a safety of the server 200 can be improved.

In the embodiment, the carrier 10 can be a printed circuit board. It can be understood that, the disclosure is not limited to the material of the carrier 10. For example, in some embodiment, the carrier 10 can further be a ceramic circuit board, a flexible printed circuit, or other types of circuit boards.

It can be understood that, the first wireless communication unit 20 is electrically coupled to the mainboard 210 via the carrier 10. Thus, the first wireless communication unit can be controlled by the mainboard 210 to emit and/or receive the wireless signal, and a communication between the server 200 and the external device 300 is achieved.

It can be understood that, the first wireless communication unit 20 can use one or more of the following communications technologies, for example, a global system for mobile communication (GSM) technology, a wideband code division multiple access (WCDMA) communication technology, a long term evolution (LTE) communication technology, a 5G communication technology, a SUB-6G communication technology, other future communications technologies, and the like. In the embodiments, the first wireless communication unit 20 can use the LTE communication technology or the 5G communication technology.

It can be understood that, the first wireless communication unit 20 includes an antenna, a power divider, a radio frequency transfer switch, and other electric component associated with wireless communication. The disclosure is not limited to a specific structure of the first wireless communication unit 20, for example, in some embodiments, the first wireless communication unit 20 can be a chip integrated with the aforementioned electric component associated with wireless communication.

In the embodiment, the positioning unit 30 is arranged on the carrier 10. Thus, when the carrier 10 is installed on the server 200, the positioning unit 30 can be configured to obtain position information, for example, current longitude and latitude data of the server 200, or the like. It can be understood that, the positioning unit 30 is electrically coupled to the mainboard 210 of the server 200. Thus, when the mainboard 210 detects that a position function is triggered (turned on), the mainboard 210 can obtain the position information of the server 200 from the positioning unit 30. In the embodiment, the positioning unit 30 can base on a global positioning system, a Beidou positioning system, or other any satellite positioning system.

In the embodiment, the one or more temperature detection units 40 are arranged adjacent to the first wireless communication unit 20 and the positioning unit 30. The one or more temperature detection units 40 are configured to detect a temperature value of the first wireless communication unit 20 and a temperature value of the positioning unit 30. The temperature value of the first wireless communication unit 20 and the temperature value of the positioning unit 30 can be used to monitor whether a potential failure of the first wireless communication unit 20 and a potential failure of the positioning unit 30 are existed. It can be understood that, if the temperature of the first wireless communication unit 20 and/or the positioning unit 30 exceed a respective threshold value, the first wireless communication unit 20 and/or the positioning unit 30 can be determined to be at potential failure states.

It can be understood that, the storage unit 50 is electrically coupled to the first wireless communication unit 20, the positioning unit 30, and the one or more temperature detection units 40. The storage unit 50 is configured to store data created according to use of each module, and/or store program instructions. It can be understood that, the disclosure is not limited to a type of the storage unit 50, the storage unit 50 can be a dynamic random access memory, a static random access memory, or other type storage unit.

In the embodiment, the storage unit 50 is a field replacement unit (FRU) chip.

In some embodiments, the server 200 further includes a second wireless communication unit 60. The second wireless communication unit 60 is arranged on the carrier 10. In the embodiment, the second wireless communication unit 60 can use a wireless fidelity communication (Wi-Fi) technology. Thus, when the carrier 10 is installed on the server 200, namely, when the second wireless communication unit 60 is electrically coupled to the mainboard 210, the second wireless communication unit 60 can be controlled by the mainboard 210 to couple to a wireless network via a wireless router, thus a communication between the server 200 and the external device 300 is achieved.

It can be understood that, at least one of the one or more temperature detection units 40 can be further arranged adjacent to the second wireless communication unit 60, to detect the temperature of the second wireless communication unit 60.

It can be understood that, when the first wireless communication unit 20 and the second wireless communication unit 60 are simultaneously arranged on the carrier 10, the server 200 can communicate with the external device 300 via the first wireless communication unit 20 and/or the second wireless communication unit 60.

It can be understood that, in the other embodiments, there may be one communication module arranged on the carrier 10, for example, there may be a second wireless communication unit 60 arranged on the carrier 10.

In the embodiment, the mainboard 210 includes a central processing unit (CPU) 211, a platform controller hub (PCH) 212, and a baseboard management controller (BMC) 213.

It can be understood that, the CPU 211 is a control center of the server 200, and is configured to use various interfaces and lines to connect various parts of the server 200. It can be understood that, the CPU 211 is electrically coupled to the PCH 212 and the BMC 213, to control various parts of the server 200 via the PCH 212 and the BMC 213. Where, the PCH 212 and the BMC 213 each is further electrically coupled to the wireless communication module 100. Thus, the CPU 211 can control the wireless communication module 100 to execute a corresponding instruction via the PCH 212 and the BMC 213, to achieve a communication between the server 200 and the external device 300.

It can be understood that, the PCH 212 is an input/output controller hub of the server 200. The CPU 211 can establish a connection with other electronic component via the PCH 212, and control a corresponding electronic component to execute a corresponding instruction.

In detail, in the embodiment, the PCH 212 can be electrically coupled to the carrier 10 via a universal serial bus (USB) 214, for example a USB3.0 interface. The PCH 212 is further electrically coupled to the first wireless communication unit 20 via the carrier 10. Thus, the PCH 212 can communicate with the first wireless communication unit 20 via a USB3.0 protocol. Thereby, the CPU 211 can output data to the first wireless communication unit 20 via the PCH 212 and the carrier 10. The first wireless communication unit 20 can process the data after receiving the data from the CPU 211, to generate a first wireless signal, and emit the first wireless signal outward. It can be understood that, after the first wireless communication unit receives a second wireless signal emitted from other external device 300, the first wireless communication unit 20 can also process the second wireless signal, to generate a corresponding data, and transmit the generated data to the CPU 211 via the carrier 10 and the PCH 212.

In the embodiment, PCH 212 can be electrically coupled to the carrier 10 via a peripheral component interconnect express (PCIe) bus 215, and can be electrically coupled to the second wireless communication unit 60 via the carrier 10. Thus, the PCH 212 can communicate with the second wireless communication unit 60 via a PCIe protocol. Thereby, the CPU 211 can output data to the second wireless communication unit 60 via the PCH 212 and the carrier 10. The second wireless communication unit 60 can process the data after receiving the data from the CPU 211, to generate a third wireless signal, and emit the third wireless signal outward, to transmit the third wireless signal to a corresponding router. It can be understood that, after the second wireless communication unit 60 receives a fourth wireless signal emitted from the router, the second wireless communication unit 60 can also process the fourth wireless signal, to generate a corresponding data, and transmit the generated data to the CPU 211 via the carrier 10 and the PCH 212.

In the embodiment, the PCH 212 is further connected to the positioning unit 30 via being electrically coupled to the carrier 10. Thus, the CPU 211 can obtain position information of the server 200 from the positioning unit 30 via the PCH 212 and the carrier 10.

It can be understood that, when the server 200 is not being activated (turned on), the BMC 213 can perform some operations on the server 200, for example perform an inspection on the server 200, a firmware update, and so on. In the embodiment, the BMC 213 can be electrically coupled to the carrier 10 via the inter-integrated circuit (I2C) bus 216, and can be further electrically coupled to the one or more temperature detection units 40 via the carrier 10 and the I2C bus 216. Thus, BMC 213 can monitor whether potential failures of the first wireless communication unit 20 and/or the second wireless communication unit 60 are existed.

In the embodiment, BMC 213 is further electrically coupled to the carrier 10 via the I2C bus, and can be further electrically coupled to the storage unit 50 via the carrier 10. Thus, BMC 213 can obtain the data (for example program instructions) of the wireless communication module 100 from the storage unit 50, to perform an inspection on the wireless communication module 100, or perform the firmware update.

It can be understood that, in some embodiments, the server 200 further includes a network interface card. A first end of the network interface card is coupled to the mainboard 210, and a second end of the network interface card is coupled to a wired network interface. Thus, the network interface card can provide a computer network service. It can be understood that, when the server 200 is equipped with the network interface card and the wireless communication module 100, the mainboard 210 can access the computer network via any one of the wireless communication module 100 and the network interface card.

It can be understood that, the wireless communication module 100 of the disclosure can be equipped on the server 200. The wireless communication module 100 of the disclosure can be coupled to the mainboard 210 of the server 200. Thus, the server 200 can be directly coupled to the wireless network, but not be coupled to the wireless network via a network cable. Thus, a freedom of the server 200 is improved, the server 200 can adapt to more application scenarios and satisfy a usage requirement of an existing industrial internet.

In the disclosure, the wireless communication module 100 includes the carrier 10, and the first wireless communication unit 20 and/or the second wireless communication unit 60. The first wireless communication unit 20 and/or the second wireless communication unit 60 are electrically coupled to the mainboard 210 via the carrier 10. Thus, problems, such as the confusion of the signal and the loss of the data, generated due to the mismatch between the first wireless communication unit 20 and/or the second wireless communication unit 60 each's interface and signal and the mainboard 210's interface and signal, can be reduced. A safety and a stably of an operation of the server 200 can be improved.

The embodiments described above are provided by way of example only, and various other modifications will be apparent to persons skilled in the field without departing from the scope of the invention as defined by the appended claims. It will be appreciated that, numerous variations and substitutions will occur to those skilled in the art without departing from the scope of the disclosure. Those variations and substitutions made in accordance with the spirit of the disclosure are within the scope of the present disclosure.

What is claimed is:

1. A wireless communication module configured to be installed on a server, wherein:
the wireless communication module comprises a carrier and a first wireless communication unit, the carrier is configured to be electrically coupled to the server;
the first wireless communication unit is arranged on the carrier, and is electrically coupled to the carrier, the first wireless communication unit is configured to be controlled by the server via the carrier to emit and/or receive the radio wave.

2. The wireless communication module according to claim 1, wherein:
the carrier is a printed circuit board.

3. The wireless communication module according to claim 1, wherein:
the carrier is configured to be electrically coupled to the server via a universal serial bus, the first wireless communication unit is configured to be controlled by the server via the carrier and the universal serial bus to emit and/or receive the radio wave.

4. The wireless communication module according to claim 3, wherein:
the wireless communication module further comprises a second wireless communication unit, the second wireless communication unit is arranged on the carrier, and is electrically coupled to the carrier; the carrier is configured to be electrically coupled to the server via a peripheral component interconnect express bus; the second wireless communication unit is configured to be controlled by the server via the carrier and the peripheral component interconnect express bus to emit and/or receive the radio wave.

5. The wireless communication module according to claim 4, wherein:
the first wireless communication unit uses a long term evolution communication technology or a 5G communication technology, and the second wireless communication unit uses a wireless fidelity communication technology.

6. The wireless communication module according to claim 1, wherein:
the wireless communication module further comprises a temperature detection unit, the temperature detection unit is arranged on the carrier, and is electrically coupled to the carrier; the temperature detection unit is electrically coupled to the server via the carrier; the temperature detection unit is arranged adjacent the first wireless communication unit; the temperature detection unit is configured to detect a temperature of the first wireless communication unit, and is configured to provide the temperature of the first wireless communication unit to the server via the carrier.

7. The wireless communication module according to claim 1, wherein:
the wireless communication module further comprises a positioning unit, the positioning unit is arranged on the carrier, and is electrically coupled to the carrier; the positioning unit is configured to be electrically coupled to the server via the carrier, and is configured to provide position information to the server via the carrier.

8. A server comprising a wireless communication module, the wireless communication module being installed on the server, wherein:
the wireless communication module comprises a carrier and a first wireless communication unit, the carrier is electrically coupled to the server;
the first wireless communication unit is arranged on the carrier, and is electrically coupled to the carrier, the first wireless communication unit is controlled by the server via the carrier to emit and/or receive the radio wave.

9. The server according to claim 8, wherein:
the carrier is a printed circuit board.

10. The server according to claim 8, wherein:
the carrier is electrically coupled to the server via a universal serial bus, the first wireless communication unit is controlled by the server via the carrier and the universal serial bus to emit and/or receive the radio wave.

11. The server according to claim 10, wherein:
the server further comprises a central processing unit and a platform controller hub, the central processing unit is electrically coupled to the platform controller hub, the platform controller hub is electrically coupled to the carrier via the universal serial bus, and is electrically coupled to the first wireless communication unit via the universal serial bus and the carrier, the central processing unit controls the first wireless communication unit to emit and/or receive the radio wave via the platform controller hub, the universal serial bus, and the carrier.

12. The server according to claim 10, wherein:
the wireless communication module further comprises a second wireless communication unit, the second wireless communication unit is arranged on the carrier, and is electrically coupled to the carrier; the carrier is electrically coupled to the server via a peripheral component interconnect express bus; the second wireless communication unit is controlled by the server via the carrier and the peripheral component interconnect express bus to emit and/or receive the radio wave.

13. The server according to claim 12, wherein:
the server further comprises a central processing unit and a platform controller hub, the central processing unit is electrically coupled to the platform controller hub, the platform controller hub is electrically coupled to the carrier via the peripheral component interconnect express bus, and is electrically coupled to the second wireless communication unit via the peripheral component interconnect express bus and the carrier, the central processing unit controls the second wireless communication unit to emit and/or receive the radio wave via the platform controller hub, the peripheral component interconnect express bus, and the carrier.

14. The server according to claim 12, wherein:
the first wireless communication unit uses a long term evolution communication technology or a 5G communication technology, and the second wireless communication unit uses a wireless fidelity communication technology.

15. The server according to claim 8, wherein:
the wireless communication module further comprises a temperature detection unit, the temperature detection unit is arranged on the carrier, and is electrically coupled to the carrier; the temperature detection unit is electrically coupled to the server via the carrier; the temperature detection unit is arranged adjacent the first wireless communication unit; the temperature detection unit is configured to detect a temperature of the first wireless communication unit, and is configured to provide the temperature of the first wireless communication unit to the server via the carrier.

16. The server according to claim 15, wherein:
the server further comprises a baseboard management controller, the baseboard management controller is electrically coupled to the carrier via the inter-integrated circuit bus, the baseboard management controller is electrically coupled to the temperature detection unit via the inter-integrated circuit bus and the carrier;
when the server is not being activated, the baseboard management controller is configured to obtain the temperature of the first wireless communication unit from the temperature detection unit via the inter-integrated circuit bus and the carrier, and monitor whether a potential failure of the first wireless communication unit is existed according to the temperature of the first wireless communication unit.

17. The server according to claim 8, wherein:
the wireless communication module further comprises a positioning unit, the positioning unit is arranged on the carrier, and is electrically coupled to the carrier; the positioning unit is electrically coupled to the server via the carrier, and is configured to provide position information of the server to the server via the carrier.
